(19) United States
(12) Patent Application Publication
(10) Pub. No.: US 2007/0289439 A1
(43) Pub. Date: Dec. 20, 2007

(54) Hydraulic Cylinder of Outrigger

(76) Inventors: Seiji Sakada, Okayama (JP); Hiroyuki Ootsuki, Osaka (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/572,064

(22) PCT Filed: Sep. 15, 2005
(86) PCT No.: PCT/JP04/13452

§ 371 Date: Jun. 7, 2007

(30) Foreign Application Priority Data
Jul. 16, 2004 (JP) 2004-209399

(51) Int. Cl. F16J 10/00

(52) U.S. Cl. 92/52

(57) ABSTRACT

A structure of a hydraulic cylinder of an outrigger should be improved to prevent a hydraulic pressure hose from being damaged, and an arrangement of the hydraulic cylinder should be improved to prevent a rod part of the hydraulic cylinder from being damaged.

A cylinder (40) is interposed between a machine frame and each of outriggers (10), which are vertically swingably disposed at opposite sides of the machine frame, so as to lift up and down the outrigger. Fluid passages (54a and 54b) are formed in a rod part (40b) of the hydraulic cylinder (40). Connection portions of fluid suction and delivery ports of the respective fluid passages (54a and 54b) to be connected to the respective hydraulic pressure hoses (51a and 52b) are disposed adjacent to a pivot of the hydraulic cylinder (40).

### TECHNICAL FIELD

The present invention relates to an outrigger equipped on a construction machine, such as a backhoe, to be used for stabilizing work by the machine. Especially, it relates to a structure of a hydraulic cylinder for controlling the vertical movement of the outrigger.

### BACKGROUND ART

Conventionally, there is a well-known technology about an outrigger equipped on a construction machine, such as a backhoe and a crane, to be used for stabilizing work at a high place.

Normally, the outrigger is provided with a hydraulic cylinder whose telescopic actuation vertically swings the outrigger. The hydraulic cylinder of the outrigger is disposed so that, when the outrigger is lowered to support the vehicle, the hydraulic cylinder is disposed so as to have its cylinder part above its rod part (as disclosed in JP 5-71139A).

The conventional hydraulic cylinder of the outrigger is vertically rotated together with the vertically rotated outrigger, thereby bending a hydraulic pressure hose. Therefore, the hydraulic pressure hose has a length enough to be prevented from being damaged. Still, during the rotation of the cylinder, it happens that the hydraulic pressure hose is bent and rubbed with a nearby frame or another part so as to be damaged.

Moreover, when the outrigger is lowered to support the vehicle, heavy load is applied on the rod part disposed under the cylinder part. Further, dust such as soil easily sticks to the outer peripheral surface of the rod part at this position close to the ground, so as to damage the rod part during telescopic actuation of the hydraulic cylinder, to interfere with the telescopic actuation of the hydraulic cylinder, and to cause oil leak from the hydraulic cylinder.

### DISCLOSURE OF THE INVENTION

### Object of the Invention

An object of the invention is to provide a hydraulic cylinder of an outrigger, improved to prevent a hydraulic pressure hose from being damaged, and to prevent a rod part of the hydraulic cylinder from being damaged.

### Means for Achieving the Object

The invention uses the following means for achieving the above object.

According to the invention, a hydraulic cylinder is interposed between a machine frame and each of outriggers, which are vertically swingably disposed at opposite sides of the machine frame, so as to raise and lower the outrigger. A fluid passage is formed in a rod part of the hydraulic cylinder. A connection portion of a fluid suction and delivery port of the fluid passage to be connected to a hydraulic pressure hose is disposed adjacent to a pivot of the hydraulic cylinder.

Further, according to the invention, the hydraulic cylinder is attached to the outrigger so that, when the outrigger is extended outwardly downward, the hydraulic cylinder is disposed so as to have the rod part above its cylinder part.

### EFFECTS OF THE INVENTION

The invention has the following effects.

According to the invention, a fluid passage is formed in a rod part of the hydraulic cylinder, and a connection portion of a fluid suction and delivery port of the fluid passage to be connected to a hydraulic pressure hose is disposed adjacent to a pivot of the hydraulic cylinder. Therefore, the hydraulic pressure hose can be shortened, and the rod part of the hydraulic cylinder is prevented from being damaged. Further, the hydraulic pressure hose is prevented from being worn when it is extended or folded. Moreover, the hydraulic pressure hose is not exposed to the outside of a frame, thereby being protected from being damaged.

The hydraulic cylinder is attached to the outrigger so that, when the outrigger is extended outwardly downward, the hydraulic cylinder is disposed so as to have the rod part above its cylinder part. Therefore, the rod part of the hydraulic cylinder is prevented from being damaged.

### BRIEF DESCRIPTION OF THE DRAWINGS

FIG. 1 is a side view of an entire backhoe-loader equipped with hydraulic cylinders of outriggers according to the invention.

FIG. 2 is a side view of the outrigger.

FIG. 3 is a perspective view of the hydraulic cylinder of the outrigger.

FIG. 4 is a front view of the hydraulic cylinder.

FIG. 5 is an enlarged sectional view of a rod part of the hydraulic cylinder.

### DESCRIPTION OF NOTATIONS

1 Backhoe-loader
8 Backhoe
10 Outrigger
11 Machine Frame
40 Hydraulic Cylinder of Outrigger
40a Cylinder Part
40b Rod Part
50a, 50b Hydraulic Pressure Pipes
51a, 51b hydraulic Pressure Hoses
54a, 54b Fluid Passages

### BEST MODE FOR CARRYING OUT THE INVENTION

An embodiment of the invention will be described.

Firstly, an entire structure of a backhoe-loader 1 equipped with outriggers 10 according to the invention.

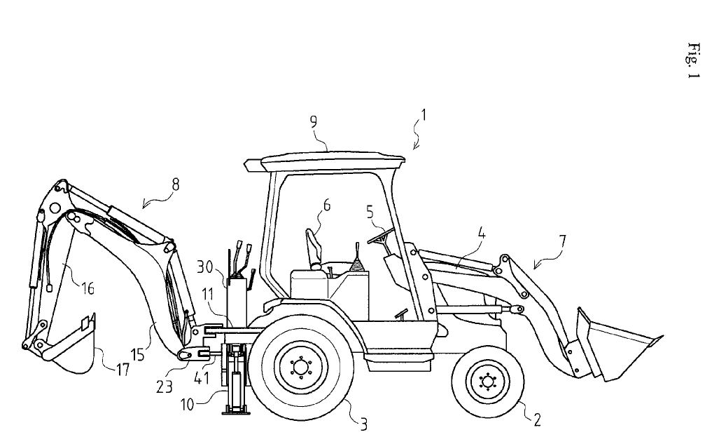

As shown in FIG. 1, backhoe-loader 1 has a body provided with a pair of front wheels 2 and a pair of rear wheels 3. On the body, a steering wheel 5 is disposed, and an operator's seat 6 is disposed behind steering wheel 5. A canopy 9 supported by four frame members is disposed above operator's seat 6. A bonnet 4 is provided on a front portion of the body so as to enclose an engine. An attitude of operator's seat 6 can be changed to face either forward or rearward. Backhoe-loader 1 is provided at a front portion of the body thereof with a front loader 7, and at a rear portion of the body thereof with a backhoe 8. An operator rotates seat 6 so as to face it forward for work by front loader 7, or to face it rearward for work by backhoe 8.

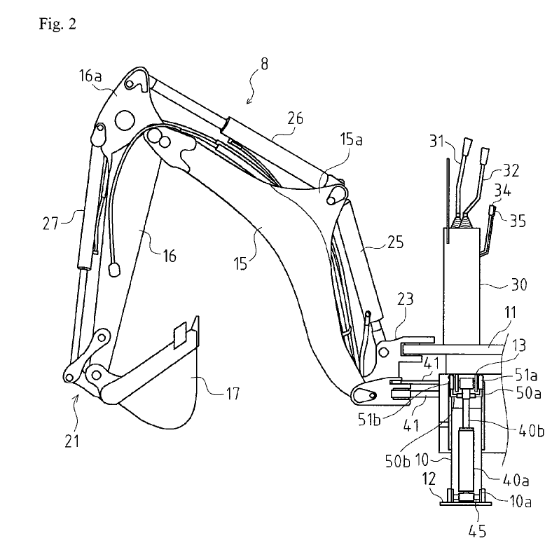

As shown in FIG. 2, backhoe 8 is attached to a machine frame 11 detachably attached to a rear end of the body through a connection mechanism. Outriggers 10 are provided on left and right sides of machine frame 11, respectively.

Backhoe 8 includes a boom 15, an arm 16, and a bucket 17. Boom 15, which is doglegged in side view, is rotatably attached to machine frame 11 through a boom bracket 23. Arm 16 is rotatably attached onto a tip portion of boom 15. Bucket 17 is pivoted onto a tip portion of arm 16 through a linkage 21. A bracket 15a projects from an intermediate rear portion of boom 15. A boom cylinder 25 is interposed between bracket 15a and boom bracket 23, so as to be telescoped for vertically rotating boom 15.

A bracket 16a projects rearward from a basic portion of arm 16. An arm cylinder 26 is interposed between bracket 16a and bracket 15a projecting from boom 15, so as to be telescoped for rotating arm 16 centered on the tip portion of boom 15.

A bucket cylinder 27 is interposed between bracket 16a of arm 16 and linkage 21, so as to be telescoped for rotating bucket 17 centered on the tip portion of arm 16.

Boom cylinder 25, arm cylinder 26 and bucket cylinder 27 are hydraulic cylinders each of which is supplied with fluid through hydraulic pressure pipes and hoses.

A control box 30 is mounted on machine frame 11. Operation levers 31 and 32 for vertically and laterally moving backhoe 8 are extended upward from control box 30. Operation levers 31 and 32 are operated so as to control fluid supply to hydraulic cylinders 25, 26 and 27 for controlling backhoe 8. Operation levers 34 and 35 for controlling respective outriggers 10 are extended rearward from control box 30. Each of operation levers 34 and 35 is operated so as to control a hydraulic cylinder 40 for vertically swinging corresponding outrigger 10.

Backhoe 8 is connected to machine frame 11 through boom bracket 23 laterally rotatably pivoted onto machine frame 11. A pair of left and right hydraulic cylinders 41 are juxtaposed between backhoe 8 and machine frame 11. Backhoe 8 can be tilted leftward or rightward relative to machine frame 11 by alternately telescoping hydraulic cylinders 41.

Due to the above structure of backhoe-loader 1, during traveling of backhoe-loader 1, operator's seat 6 is faced forward, and steering wheel 5 is operable for steering the vehicle body. To operate front loader 7, an operator sitting on seat 6, which is still faced forward (during forward traveling), controls operation levers in the operator's room.

To operate backhoe 8 and outriggers 10 disposed at the rear portion of the body, operator's seat 6 is exactly rotatably reversed so as to control the operation levers projecting from the control box at the rear portion of the body.

A structure of the outriggers will be detailed.

As shown in FIGS. 2, 3 and 4, outriggers 10 are provided on the left and right sides of a rear portion of machine frame 11. During excavation or other work, outriggers 10 are extended downwardly sidewise and earthed, thereby stabilizing the body without tumbling or other trouble in correspondence to any ground surface condition.

Outriggers 10 are provided with respective telescopically movable hydraulic cylinders 40. The telescopic movements of hydraulic cylinders 40 are controlled so as to swing respective outriggers 10 upward or downward. Left and right brackets 13 project leftward and rightward from machine frame 11, and each of outriggers 10 is pivoted onto each of brackets 13, so as to be rotatably attached to machine frame 11.

An earthed plate 12 is pivoted on the earthed tip of each of outriggers 10, so as to be rotated to face its bottom surface downward during the vertical swing of outrigger 10. Hydraulic cylinders 40 are attached to respective outriggers 10 so that, when left and right outriggers 10 are lowered, i.e., extended downward in lateral opposite directions, hydraulic cylinders 40 are disposed on the upper sides of respective outriggers 10 (contrarily, when outriggers 10 are raised to be folded, hydraulic cylinders 40 are disposed laterally inward of respective outriggers 10), and each of hydraulic cylinders 40 extended to lower respective outriggers 10 has its rod part 40b disposed above its cylinder part 40a.

When outriggers 10 are lowered, i.e., extended downward in lateral opposite directions, a pair of projections 10a project upward from the earthed tip portion of each of outriggers 10, a tip (lower end on the head side) of cylinder part 40a of hydraulic cylinder 40 is pivoted on a pin 45 between the pair of projections 40a, and a tip (upper end) of rod part 40b, i.e., the other end of hydraulic cylinder 40, is pivoted on a pin 46 disposed at an upper portion of each of brackets 13 projecting from machine frame 11.

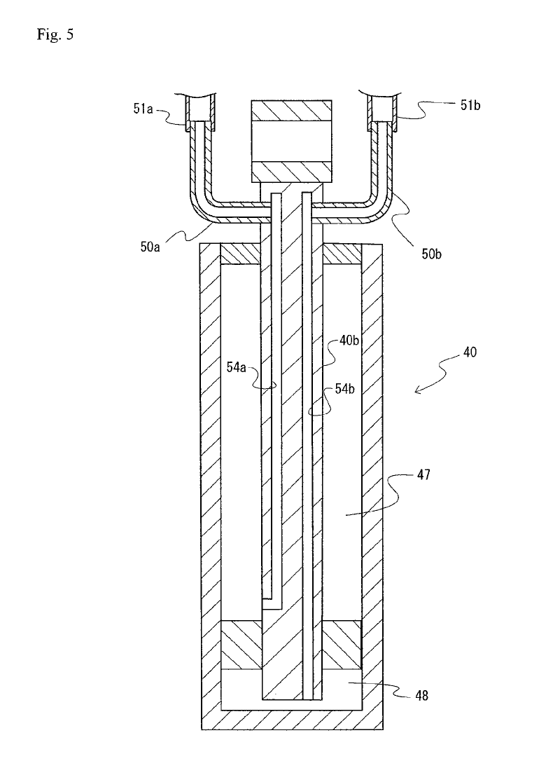

As shown in FIG. 5, a pair of fluid passages 54a and 54b are formed within rod part 40b. Hydraulic pipes 50a and 50b are connected to the tip portion of rod part 40b so as to be connected to respective fluid passages 54a and 54b. Hydraulic pressure hoses 51a and 51b are connected to respective hydraulic pressure pipes 50a and 50b, and connected at the other ends thereof to a control valve under control box 30.

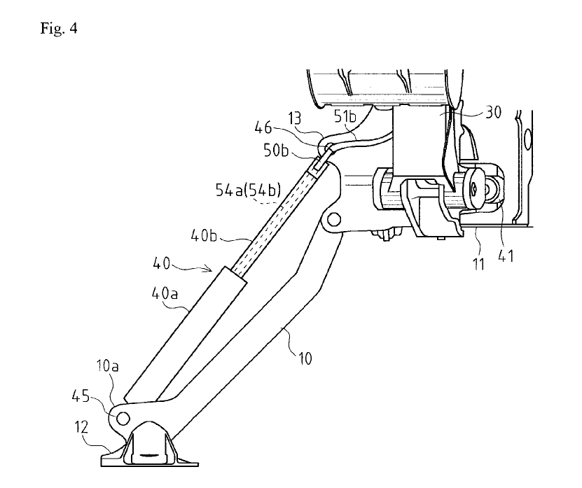

Hydraulic pressure pipes 50a and 50b are made of steel pipes or the like. As shown in FIGS. 2 and 5, hydraulic pressure pipes 50a and 50b project in fore-and-aft opposite directions from an upper portion of rod part 40b, and are bent upward at their intermediate portions so as to be L-shaped. As shown in FIGS. 4 and 5, when viewed in front, ends of hydraulic pressure pipes 50a and 50b to be connected to respective hydraulic pressure hoses 51a and 51b are disposed adjacent to the axis of pin 46 serving as a rotation fulcrum of hydraulic cylinder 40, whereby the movement of their connection portions to be connected to hydraulic pressure hoses 51a and 51b during the vertical rotation of hydraulic cylinder 40 is reduced as much as possible, so as to reduce their bend degrees, i.e., to reduce bending load thereon, thereby improving hydraulic pressure hoses 51a and 51b in durability. Alternatively, a swivel joint or another member replacing pin 46 may be interposed between fluid passages 54a and 54b and hydraulic pressure pipes 50a and 50b, so as to prevent the hydraulic pressure hoses from being bent during rotation of the hydraulic cylinder.

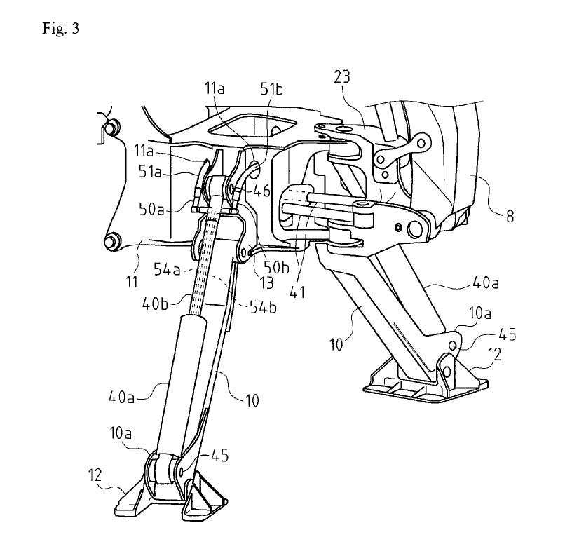

As shown in FIG. 3, hydraulic pressure hoses 51 connected to tips of respective hydraulic pressure pipes 50a and 50b are extended toward the center of the body, and are passed through respective circular openings 11a and 11b formed in side portions of machine frame 11, so as to be connected to control box 30 from the inside of machine frame 11. Fluid passages 54a and 54b formed within rod part 40b are opened at the other ends thereof to a head side chamber 48 and a rod side chamber 47 in cylinder part 40a, respectively. The operation levers provided on control box 30 are operated to shift the control valves so as to change directions of fluid supplied to respective head side chamber 48 and rod side chamber 47 in cylinder part 40a through hydraulic pressure hoses 51a and 51b, hydraulic pressure pipes 50a and 50b and fluid passages 54a and 54b, respectively, thereby controlling the telescopic actuation of hydraulic cylinder 40.

Due to the above structure of hydraulic cylinders 40 of the outriggers, when an operator operates the operation levers for extending hydraulic cylinders 40 having been contracted, earthed plates 12 and outriggers 10 are rotated outwardly downward from machine frame 11, and earthed plates 12 are pressed down against the ground, so that outriggers 10 are stretched to support the body.

Whether the hydraulic cylinders of the outriggers are contracted or extended, the change of distance between machine frame 11 and each of hydraulic pressure pipes 50a and 50b is small so as to reduce the bends of hydraulic pressure hoses 51a and 51b.

As mentioned above, each of hydraulic cylinders 40 has proximal rod part 40b and distal cylinder part 40a with respect to the body. In other words, when each of outriggers 10 is extended outwardly downward from the body, its hydraulic cylinder 40 is disposed so as to have rod part 40b above cylinder part 40a. Therefore, upper rod part 40b is disposed at a distance from the ground surface so as to hardly have soil, sand or the like stuck thereon, thereby reducing damage to the outer peripheral portion of rod part 40b during the telescopic actuation of the hydraulic cylinder.

Fluid passages 54a and 54b are formed within rod part 40b of each of hydraulic cylinders 40 in parallel to each other along the axis of rod part 40b. Portions of connecting the end ports (for suction and delivery of fluid) of fluid passages 54a and 54b to respective hydraulic pressure hoses 51a and 51b are disposed adjacent to the pivot for rotating hydraulic cylinder 40. Conventionally, the pipes are extended to the cylinder part so as to have a surplus length such as to moderate bends thereof during the rotation of the hydraulic cylinder. Contrarily, the present hydraulic pressure hoses, whose tips are disposed adjacent to the pivot, have almost constant distances from the machine frame even while the hydraulic cylinder is telescoped. Thus, the hydraulic pressure hoses do not have the surplus length for moderating bends thereof, thereby being shortened. Further, since the hydraulic pressure pipes and hoses are disposed at the tip of the rod part close to the machine frame, the hydraulic pressure pipes have almost no part exposed to the outside of the body, thereby being prevented from being damaged by an external obstacle.

### INDUSTRIAL APPLICABILITY

The hydraulic cylinder of an outrigger according to the present invention is industrially applicable, which is used for not only the above-mentioned construction machines such as a backhoe but also transportation machines such as a truck, and other machines.

1-2. (canceled)

3. A hydraulic cylinder of an outrigger, wherein the hydraulic cylinders are vertically rotatably pivoted together with the respective outriggers on respective opposite sides of a machine frame so as to raise and lower the respective outriggers, characterized in that each of the hydraulic cylinders is disposed laterally inward of the corresponding outrigger when the outrigger is raised, in that each of the hydraulic cylinders is disposed above the corresponding outrigger so as to have its rod part above its cylinder part when the outrigger is lowered to be extended outwardly downward, in that a fluid passage is formed in the rod part of each of the hydraulic cylinders, in that a connection portion of a fluid suction and delivery port of the fluid passage to be connected to a hydraulic pressure hose is disposed adjacent to an axis of a pin serving as a rotation fulcrum of the hydraulic cylinder, and in that the machine frame is provided with openings adjacent to the respective pins so as to pass the respective hydraulic pressure hoses therethrough to the inside of the machine frame.
